(19) United States
(12) Patent Application Publication
(10) Pub. No.: US 2007/0034247 A1
(43) Pub. Date: Feb. 15, 2007

(54) Rectenna solar cell hybrid panel and hybrid photovoltaic power generation system

(75) Inventors: Kazuyuki Takada, Tokyo (JP); Atsushi Yamamoto, Tokyo (JP); Tomohiro Mizuno, Tokyo (JP); Hiroshi Ikematsu, Tokyo (JP); Hiroyuki Satou, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Mitsubishi Denki Kabushiki Kaisha, Tokyo (JP)

(21) Appl. No.: 10/573,589

(22) PCT Filed: Mar. 30, 2004
(86) PCT No.: PCT/JP04/04543

§ 371 Date: Mar. 27, 2006

(51) Int. Cl. H02N 6/00

(52) U.S. Cl. 136/244; 136/292

(57) ABSTRACT

The description relates to a rectenna solar-battery hybrid panels that not only receive electric power transmitted by microwaves after the electric energy has been generated from sunlight, but also gain sunlight energy on the open faces of the panels, and to hybrid solar photovoltaic generation systems. In the rectenna solar-battery hybrid panel, a plurality of solar battery cells for receiving sunlight and converting the sunlight into electricity and a plurality of microwave receiving antenna elements for receiving microwaves transmitted through space are provided. dc electric power is obtained from microwave power, having been received by the microwave receiving antenna elements, being rectified by a rectifying circuit. Stable electric power can be obtained from the output of the solar battery cells and the rectifying circuit.

### TECHNICAL FIELD

The present invention relates to rectenna solar-battery hybrid panels that not only receive electric power transmitted by microwaves after the electric energy has been generated from sunlight, but also gain sunlight energy on the open faces of the panels, and to hybrid solar photovoltaic generation systems.

### BACKGROUND ART

Electric power generation systems using sunlight include scale-wise various ones such as a solar-battery panel composed of several solar-battery cells and used for an electric calculator, a solar battery panel installed on a building, and a solar battery panel having excellent durability and installed on a solar power station. Theoretically, solar photovoltaic generation on the earth using these systems is not always effective due to atmospheric attenuation of sunlight, and due to lightness in the daytime and darkness at night. As a solar photovoltaic generation system in space, a solar battery panel mounted on an artificial satellite is well known, and using the panel, the artificial satellite generates by itself electric power required for observation, communication, etc. so as to achieve its mission.

On the other hand, a system for receiving sunlight and generating electric power in space and transmitting the electric power to a specific location, such as a specific point on the earth or in space, is supported by progress of communication technology, the construction technology for a large-scaled space structure, etc., owing to the result of recent space development, which has vigorously enhanced its research and development. One of such technologies is disclosed in Japanese Laid-Open Patent Publication 309,938/2003, that is, a technology in which microwave power from a power generation satellite placed in space is radiated to a power base or a power consumption area on the earth, so as to obtain power by receiving it using a receiving antenna.

However, in the solar photovoltaic generation system on the earth, even though a large-scaled solar power station has been established on the earth, a problem has been that generation is impossible during the night when sunlight is not incident, and generation efficiency also decreases in cloudy and rainy weather. Moreover, in a case in which the solar battery panel is mounted on the artificial satellite, and the satellite generates electric power, a problem has also been that when an astronomic object, such as the earth, around which the artificial satellite revolves eclipses the artificial satellite, generation cannot be carried out by the solar battery panel Furthermore, in a system for receiving sunlight and generating electric power in space and wireless-transmitting the power to the earth, in order to obtain significant electric power on the earth, receiving antenna arrays must be set on a large area site; therefore, a problem has been that the manufacturing cost of such a receiving antenna, etc. is relatively expensive compared to the amount of generated power.

### DISCLOSURE OF THE INVENTION

An objective of the present invention, which is made to solve problems as described above, is to obtain a rectenna solar-battery hybrid panel and a hybrid solar photovoltaic generation system that can supply electric power even at night in the cloudy daytime, or in an eclipse by an astronomic object, etc. during which sunlight is not incident, and can curtail high manufacturing cost of an electric power generation system using wireless transmission.

In order to achieve this objective, a rectenna solar-battery hybrid panel according to the present invention includes: a plurality of solar battery cells for receiving sunlight and converting it into electricity; a plurality of microwave receiving antenna elements for receiving microwaves transmitted through space; and a rectifying circuit for rectifying the microwaves received by the microwave receiving antenna elements; whereby electric power is obtained from the output of the solar battery cells and the rectifying circuit. According to this configuration, both dc electric power amount obtained from the solar battery cell and dc electric power obtained from the microwave being rectified by the rectifying circuit can be obtained; consequently, the electric-power generation capability of the panel can be increased. Moreover, according to this configuration, even during the time period, such as at night or in the cloudy daytime, in which the photovoltaic efficiency decreases in the panel, stable electric power can be obtained due to the electric-power generation by receiving the microwave. A rectenna solar-battery hybrid panel according to the present invention further includes a transparent base, wherein the plurality of solar battery cells are provided inside the base, the plurality of microwave receiving antenna elements is provided on the upper face of the base, and the rectifying circuit is provided on the bottom face of the base. According to this configuration, the solar battery cells can be densely arranged, and thus large dc electric power can be obtained; moreover, because the microwave receiving antenna elements are provided outside the base, the attenuation does not occur in the base, and thereby the receiving efficiency can be improved. A rectenna solar-battery hybrid panel according to the present invention further includes a transparent base, wherein the plurality of solar battery cells and the plurality of microwave receiving antenna elements are provided inside the base, and the rectifying circuit is provided on the bottom face of the base. According to this configuration, the solar battery cells and the microwave receiving antenna elements can be protected by the base against the external environment, and the degree of freedom to arrange these cells and elements can be increased. Moreover, a rectenna solarbattery hybrid panel according to the present invention further includes a transparent base, and a substrate provided on one of the faces of the base; wherein the plurality of solar battery cells are provided inside the base, and the plurality of microwave receiving antenna elements and the rectifying circuit is provided on the top or bottom face of the substrate, respectively. According to this configuration, the productivity of the configuration composed of the microwave receiving antenna elements, the base, the rectifying circuit, and outputting lines can be improved. Furthermore, a rectenna solar-battery hybrid panel according to the present invention further includes a transparent base provided with the plurality of solar battery cells; and a film-like substrate provided on one of the faces of the base, and provided with the plurality of microwave receiving antenna elements and the rectifying circuit. According to this configuration, because the configuration composed of the microwave receiving antenna elements, the rectifying circuit, and the film-like substrate, and the configuration composed of the solar battery cells, and the base can be independently manufactured, in each configuration, the number of parts can be reduced, and the productivity can be improved accordingly.

A hybrid solar photovoltaic generation system according to the present invention includes: a bus for controlling an artificial satellite; a mission module for performing observation and communication using the artificial satellite; and a rectenna solar-battery hybrid panel including a plurality of solar battery cells for receiving sunlight and converting it into electricity, a plurality of microwave receiving antenna elements for receiving a microwave transmitted through space, and a rectifying circuit for rectifying the microwave received by the microwave receiving antenna elements, so as to supply to the bus and the mission module electric power generated by the rectenna solar-battery hybrid panel. According to this configuration, the artificial satellite can always obtain stable electric power without suffering from the adverse effect of eclipses due to astronomic objects such as the earth, etc.

Moreover, a hybrid solar photovoltaic generation system according to the present invention includes: a group of hybrid panels configured by arranging a plurality of rectenna solar-battery hybrid panels that include a plurality of solar battery cells for receiving sunlight and converting into electricity, a plurality of microwave receiving antenna elements for receiving a microwave transmitted through space, and a rectifying circuit for rectifying the microwave received by the microwave receiving antenna elements; an electric power controller for combining electric power outputted from the group of hybrid panels; and a transmission line for supplying to an electric-power network the electric power combined by and outputted from the electric power controller. According to this configuration, because not only electric power obtained by the solar photovoltaic generation but also electric power transmitted through the microwave can be stably obtained, by combining these, a stable amount of electric power can be secured.

Furthermore, a hybrid solar photovoltaic generation system according to the present invention includes: a rectenna solar-battery hybrid panel, installed on a building, including a plurality of solar battery cells for receiving sunlight and converting it into electricity, a plurality of microwave receiving antenna elements for receiving a microwave transmitted through space, and a rectifying circuit for rectifying the microwave received by the microwave receiving antenna elements; and an electric power controller for supplying to the building the amount of electric-power shortage from an existing electric-power network, when the amount of electric power supplied from the rectenna solar-battery hybrid panel is less than the amount of electric-power demand within the building, and supplying to the existing electric-power network remaining electric power from the rectenna solar-battery hybrid panel, when the amount of electric power supplied from the rectenna solar-battery hybrid panel is more than the amount of electric-power demand inside the building. According to this configuration, stable electric power can always be obtained without regard to in the daytime or at night; moreover, because the system supplies to the existing electric power network remaining electric power, the load on a power generating station supplying electric power to existing electric power networks can be reduced.

### BRIEF DESCRIPTION OF DRAWINGS

FIG. 1 is a configurational view illustrating a first example of a rectenna solar-battery hybrid panel according to Embodiment 1 of the present invention;

FIG. 2 is a configurational view illustrating a second example of a rectenna solar-battery hybrid panel according to Embodiment 1 of the present invention;

FIG. 3 is a configurational view illustrating a third example of a rectenna solar-battery hybrid panel according to Embodiment 1 of the present invention;

FIG. 4 is a configurational view illustrating a fourth example of a rectenna solar-battery hybrid panel according to Embodiment 1 of the present invention;

FIG. 5 is an outline view illustrating a hybrid solar photovoltaic generation system applied to an artificial satellite according to Embodiment 2 of the present invention;

FIG. 6 is a functional block diagram illustrating the hybrid solar photovoltaic generation system according to Embodiment 2 of the present invention;

FIG. 7 is a schematic view explaining an electric-power transmitting method in response to orbital positions of the artificial satellite in the hybrid solar photovoltaic generation system according to Embodiment 2 of the present invention;

FIG. 8 is a schematic view, when the artificial satellite and an electrical power generation satellite he in the same orbit, explaining the positions of both satellites according to Embodiment 2 of the present invention;

FIG. 9 is an outline view illustrating a hybrid solar photovoltaic generation system according to Embodiment 3 of the present invention;

FIG. 10 is a configurational block diagram illustrating the hybrid solar photovoltaic generation system according to Embodiment 3 of the present invention; and

FIG. 11 is a configurational view illustrating a hybrid solar photovoltaic generation system for buildings such as a house, according to Embodiment 4 of the present invention.

### BEST MODE FOR CARRYING OUT THE INVENTION

Embodiment 1.

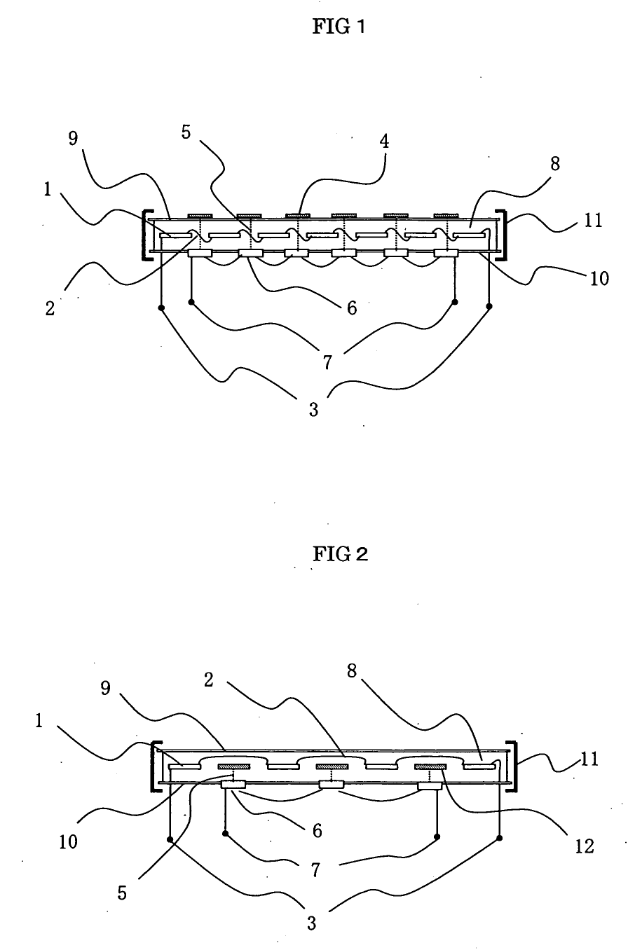

Rectenna solar-battery hybrid panels according to Embodiment 1 of the present invention are explained referring to FIG. 1-FIG. 4. Examples related to the different structures of the rectenna solar-battery hybrid panels are illustrated in FIG. 1-FIG. 4. In FIG. 1, numeral 1 denotes solar battery cells, and a plurality of cells is arranged in a rectenna solar-battery hybrid panel. Numeral 2 denotes inter connectors for connecting in series the solar battery cells; and numeral 3 denotes solar-battery output terminals for outputting generated dc electric power. Numeral 4 denotes microwave receiving antenna elements for receiving microwave power transmitted through space; numeral 5 denotes outputting lines of the microwave receiving antenna elements 4; numeral 6 denotes rectifying circuits for rectifying the received microwave power and converting the power into dc electric power; and numeral 7 denotes rectenna outputting terminals for outputting the dc electric power obtained from the received microwave power. In FIG. 1, each pair of the microwave receiving antenna elements 4, the outputting lines 5, and the rectifying circuits 6, correspondingly provided on the upper and lower sides, is referred to as a rectenna element, and a plurality of the rectenna elements are provided in the rectenna solar-battery hybrid panel. By connecting in series the plurality of rectenna elements, large electric power can be obtained. Numeral 8 denotes a base formed of transparent resin or the like; numeral 9 denotes a front substrate, made of glass or the like, provided on the upper face of the base 8; numeral 10 denotes a back substrate, made of glass or the like, provided on the bottom face of the base 8; and numeral 11 denotes a frame of the rectenna solar-battery antenna panel. The solar battery cells 1 and the inter connectors 2 are provided inside the base 8. Regarding the size of the rectenna solar-battery hybrid panel, although the surface area thereof varies depending on the size and the number of the solar battery cells 1, etc., the thickness is normally approximately from several centimeters to several dozen centimeters. Moreover, by thinning the solar battery cells 1 and the microwave receiving antenna elements 4, and then integrating the base 8, the front substrate 9, and the back substrate 10, a film-like rectenna solar-battery hybrid panel can be also manufactured; in such cases, it may also be possible that the thickness is made not thicker than 1 cm. Because it is necessary that sunlight is incident on the solar battery cells 1, the material of the base 8 and the front substrate 9 is preferable to be transparent; on the other hand, because the back substrate 10 does not include such requirement, it is not necessary that the material is transparent. The microwave receiving antenna elements 4 are arrayed on the front substrate 9, the rectifying circuits 6 are provided on the back substrate 10 so as to form pairs of upper and lower sides, and the microwave receiving antenna elements 4 and the rectifying ciruits 6 are connected with the outputting lines 5 that pass through the base 8. Each arrangement of the microwave receiving antenna elements 4 is optimized so as to improve the receiving efficiency of the microwave; that is, the elements are arrayed in such a way that each spacing is approximately 0.7 times as wide as the wavelength of the received microwave. Furthermore, if the rectifying circuits 6 are integrated into smaller size, a thin-type rectenna solar-battery hybrid panel can be configured.

The operation is explained referring to the example illustrated in FIG. 1. Sunlight passes through the front substrate 9 and the base 8, and is incident on the solar battery cells 1. In the solar battery cells 1, dc electric power is generated by the photovoltaic phenomenon. Each of the solar battery cells 1 is connected in series with each of the inter connectors 2, and the dc electric power generated in each of the solar battery cells 1 is outputted across the solar-battery output terminals 3. On the other hand, the microwave receiving antenna elements 4 receive the microwave transmitted through space. The received microwave power is rectifying by the rectifying circuits 6, and converted into dc electric power. Each of the rectifying circuits 6 is connected in series, and the dc electric power is outputted from the rectenna outputting terminals 7. According to the example illustrated in FIG. 1, the solar battery cells 1 can be densely arranged, and large dc electric power can be obtained from the solarbattery output terminals; moreover, because the microwave receiving antenna elements 4 are provided outside the base 8, comparing with the case in which the elements are provided inside the base 8, the attenuation does not occur in the base 8, resulting in an advantage in that receiving efficiency is improved.

Next, based on FIG. 2, another example of a rectenna solar-battery hybrid panel according to Embodiment 1 is explained. In FIG. 2, numeral 12 denotes microwave receiving antenna elements provided inside the base 8. The solar battery cells 1 and the microwave receiving antenna elements 12 are placed in the approximately same plane or in the different planes inside the base 8. In FIG. 2, the circuits and the elements in which the same numerals are used as in FIG. 1 represent the same or equivalent ones in FIG. 1.

The operation is explained referring to the example illustrated in FIG. 2. Sunlight passes through the front substrate 9 and the base 8, and is incident on the solar battery cells 1. In the solar battery cells 1, dc electric power is generated by the photovoltaic phenomenon. Each of the solar battery cells 1 is connected in series with each of the inter connectors 2, and the dc electric power generated in each of the solar battery cells 1 is outputted across the solar-battery output terminals 3. On the other hand, the microwave receiving antenna elements 12 receive the microwave power that has been transmitted through space and has passed through the front substrate 9 and the base 8. The received microwave power is rectified by the rectifying circuits 6, and converted into dc electric power. Each of the rectifying circuits 6 is connected in series, and the dc electric power is outputted from the rectenna outputting terminals 7. According to the example illustrated in FIG. 2, because the solar battery cells 1 and the microwave receiving antenna elements 12 are placed inside the base 8, by the front substrate 9 and the base 8, these elements can be protected from the external environment. Moreover, when the solar battery cells 1 and the microwave receiving antenna elements 12 are placed in the same plane, each spacing for the solar battery cells 1 becomes coarse comparing with that in the example illustrated in FIG. 1; however, it is advantageous that sunlight is incident on the solar battery cells 1 without being shielded by the microwave receiving antenna elements 12, and the receiving efficiency is improved; moreover, their manufacturing is also relatively easy. On the other hand, when the solar battery cells 1 and the microwave receiving antenna elements 12 are placed in the different planes, because the panel becomes multilayered inside the base 8, therefore their manufacturing becomes difficult; however, because both the solar battery cells 1 and the microwave receiving antenna elements 12 can be more freely placed, dc electric power generation can be increased by placing the solar battery cells 1 more densely comparing to the case in which the cells are provided in the same plane, and shielding by the microwave receiving antenna elements 12 in the solar battery cells 1 can be also made smaller than that in the example illustrated in FIG. 1, it is advantageous that generation efficiency of the solar battery cells 1 is improved.

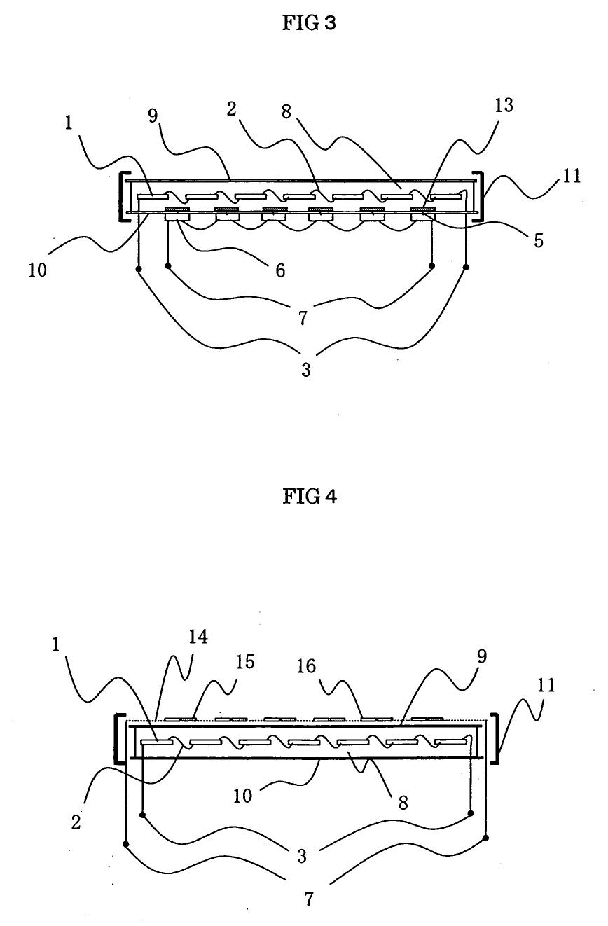

Next, based on FIG. 3, another example of a rectenna solarbattery hybrid panel according to Embodiment 1 is explained. In FIG. 3, numeral 13 denotes microwave receiving antenna elements provided on the back substrate 10. The microwave receiving antenna elements 13 are provided on one of the faces of the back substrate 10, meanwhile the rectifying circuits 6 are provided on the other face of the back substrate 10; then, the outputting lines 5 passing through the back substrate 10 connect the microwave receiving antenna elements 13 with the rectifying circuits 6, which form pairs of corresponding upper and lower sides. In FIG. 3, the circuits and the elements for which the same numerals are used as in FIG. 1 represent the same or equivalent ones in FIG. 1.

The operation is explained referring to the example illustrated in FIG. 3. Sunlight passes through the front substrate 9 and the base 8, and is incident on the solar battery cells 1. In the solar battery cells 1, dc electric power is generated by the photovoltaic phenomenon. Each of the solar battery cells 1 is connected in series with each of the inter connectors 2, and the dc electric power generated in each of the solar battery cells 1 is outputted across the solar-battery output terminals 3. On the other hand, the microwave receiving antenna elements 13 receive the microwave power that has been transmitted through space, and has passed through the front substrate 9 and the base 8. The received microwave power is rectified by the rectifying circuits 6, and converted into dc electric power. Each of the rectifying circuits 6 is connected in series, and the dc electric power is outputted from the rectenna outputting terminals 7. According to the example illustrated in FIG. 3, the microwave power having been transmitted through space is attenuated by the front substrate 9, base 8, and the solar battery cells 1 placed on the microwave receiving antenna elements 13; however, because the solar battery cells 1 can be densely placed, the dc electric power outputted from the solar-battery output terminals 3 can be increased; in addition, because the microwave receiving antenna elements 13, the back substrate 10, the rectifying circuits 6, and the outputting lines 5 can be integrated (for example, the integration is performed by etching or printing onto the back substrate 10), the microwave receiving antenna elements 13, the back substrate 10, the rectifying circuits 6, and the outputting lines 5 can be manufactured as an assembly unit, it is advantageous that productivity is improved.

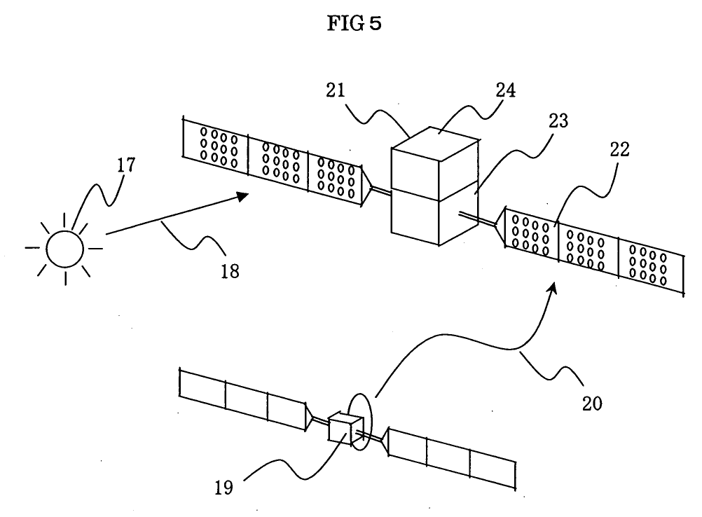

Next, based on FIG. 4, another example of a rectenna solar-battery hybrid panel according to Embodiment 1 is explained. In FIG. 4, numeral 14 denotes a light-transparent-type film-like substrate, numeral 15 denotes microwave receiving antenna elements provided on the substrate 14, and numeral 16 denotes rectifying circuits provided on the substrate 14. As an example of this configuration, the panel can be configured in such a way that the microwave receiving antenna elements 15 and the rectifying circuits 16 are formed by printing, etc. on the light-transparent-type film-like substrate. The light-transparent-type film-like substrate 14 is glued on the front substrate 9. In FIG. 4, the circuits and the elements for which the same numerals are used as in FIG. 1 represent the same or equivalent ones in FIG. 1.

The operation is explained referring to the example illustrated in FIG. 4. Sunlight passes through the front substrate 9 and the base 8, and is incident on the solar battery cells 1. In the solar battery cells 1, dc electric power is generated by the photovoltaic phenomenon. Each of the solar battery cells 1 is connected in series with each of the inter connectors 2, and the dc electric power generated in each of the solar battery cells 1 is outputted across the solar-battery output terminals 3. On the other hand, the microwave receiving antenna elements 15 receive the microwave power that has been transmitted through space. The received microwave power is rectified by the rectifying circuits 6, and converted into dc electric power. Each of the rectifying circuits 6 is connected in series, and the dc electric power is outputted from the rectenna outputting terminals 7. According to the example illustrated in FIG. 4, because a configurational unit composed of the microwave receiving antenna elements 15, the rectifying circuits 16, and the light-transparent-type film-like substrate 14, and a configurational unit composed of the solar battery cells 1, the inter connectors 2, the solar-battery output terminals 3, the base 8, the front substrate 9, and the back substrate 10 can be independently manufactured, in each configuration, the number of parts can be reduced, so that productivity can be improved. Moreover, because the microwave receiving antenna elements 15 and the rectifying circuits 16 can be formed by printing, etc. on the light-transparent-type film-like substrate 14, and in addition, wiring work can also be omitted depending on the printing method, productivity can be improved and low-cost manufacturing can be achieved. Furthermore, in FIG. 4, the configuration excluding the light-transparent-type film-like substrate 14, the microwave receiving antenna elements 15, and the rectifying circuits 16, that is, the configuration including the solar battery cells 1, the inter connectors 2, the solar-battery output terminals 3, the base 8, the front substrate 9, and the back substrate 10 is same as that of a general-use solar battery panel. Therefore, it is also advantageous that, by gluing on a conventional solar-battery panel the configurational unit composed of the light-transparent-type film-like substrate 14, the microwave receiving antenna elements 15, and the rectifying circuits 16, so that a rectenna solar-battery hybrid panel can be easily manufactured.

In the rectenna solar-battery hybrid panels according to Embodiment 1 illustrated in Fig. 1-FIG. 4, the solar-battery output terminals 3 and the rectenna outputting terminals 7 are separately described; however, the panels may be configured in such a way that the output from the solar battery and from the rectenna is combined together, and thus electric power is obtained from a terminal unit.

According to the rectenna solar-battery hybrid panels related to Embodiment 1 of the present invention, illustrated in FIG. 1-FIG. 4, both the dc electric power can be obtained, one of which can be obtained by a plurality of the solar battery cells for receiving sunlight and photoelectric converting it, while the other can be obtained by, using the rectifying circuit, rectifying microwave power that has been transmitted from an electric-power-generation satellite or another microwave transmission apparatus, transmitted through space, and received by a plurality of the microwave receiving antenna elements; as a result, the electric-power generation capability of the panels can be increased. Moreover, because of this configuration, even for a time period, such as at night or in the cloudy daytime, in which the photovoltaic efficiency decreases in the panels, due to the electric-power generation by receiving the microwave power, stable electric power can be obtained.

Embodiment 2.

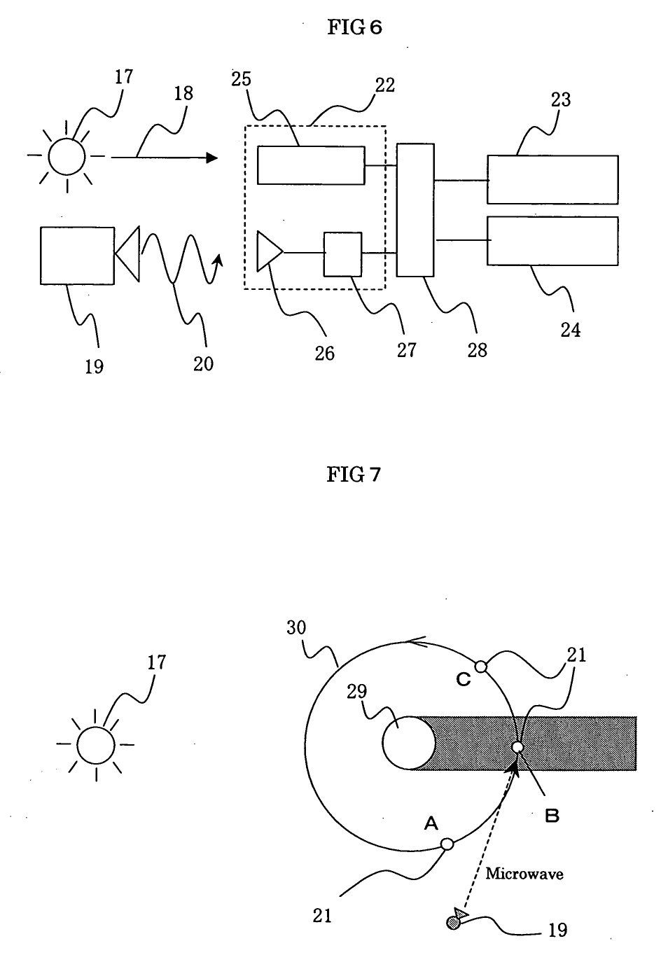

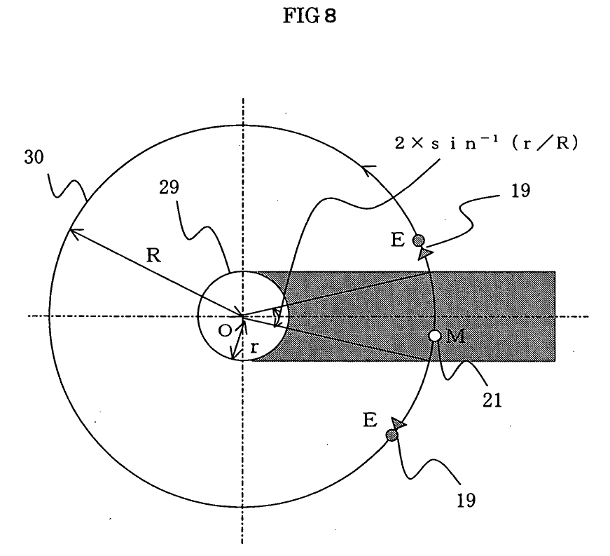

A hybrid solar photovoltaic generation system, applied to an artificial satellite, according to Embodiment 2 of the present invention is explained based on FIG. 5-Fig. 8. FIG. 5 is an outline view of the hybrid solar photovoltaic generation system, applied to the artificial satellite, according to Embodiment 2 of the present invention; FIG. 6 is a functional block diagram of the hybrid solar photovoltaic generation system according to Embodiment 2 of the present invention; FIG. 7 is a schematic view explaining an electric-power transmitting method in response to orbital positions of the artificial satellite in the hybrid solar photovoltaic generation system according to Embodiment 2 of the present invention; and FIG. 8 is a schematic view, when the artificial satellite and an electrical power generation satellite lie in the same orbit, explaining the positions of the satellites according to Embodiment 2 of the present invention.

In FIG. 6, numeral 17 denotes the sun to be a light source; numeral 18 denotes sunlight from the sun 17, numeral 19 denotes a power generation satellite for converting into microwave power dc electric power obtained by photovoltaic generation, etc. and for transmitting the microwave power; numeral 20 denotes a microwave transmitted from the power generation satellite 19; and numeral 21 denotes an artificial satellite. In the artificial satellite 21, numeral 22 denotes rectenna solar-battery hybrid panels. Numeral 23 denotes a bus of the artificial satellite 21, while numeral 24 denotes a mission module of the artificial satellite 21; thus, the bus 23 controls the artificial satellite, for example, controls the attitude of the artificial satellite, while the mission module 24 performs missions of the artificial satellite, for example, performs observation as well as communication. The rectenna solar-battery hybrid panels 22 provided in the artificial satellite 21 are configured as the examples each corresponding to FIG. 1-FIG. 4 having been explained in Embodiment 1. Hereinafter, it is assumed that, when described as “the hybrid solar photovoltaic generation system”, the system may be defined as a partial system of an electric power system provided in the artificial satellite 21, or may be defined as an entire system including both the power generation satellite 19 and the artificial satellite 21.

In a case in which the artificial satellite 21 lies in space in which the satellite is exposed to the sunlight 18, similar to cases of a normal artificial satellite, the sunlight 18 is incident on the rectenna solar-battery hybrid panels 22, and dc electric power is generated by the photovoltaic effect; then, the dc electric power is made to be driving power for the bus 23 and the mission module 24. When the artificial satellite 21 is eclipsed by an astronomic object such as the earth, and electric power cannot be generated by the sunlight 18, the microwave 20 transmitted from the power generation satellite 19 is received by the rectenna solar-battery hybrid panels 22; thus, the dc electric power obtained from the received microwave power being converted into dc electric power can be made to be the driving power for the bus 23 and the mission module 24 of the satellite. Therefore, in the hybrid solar photovoltaic generation system for artificial satellites according to Embodiment 2 of the present invention, the artificial satellite 21 can always obtain stable electric power without suffering from the effect of eclipses, etc. due to astronomic objects such as the earth, etc. Moreover, even in a case in which the solar battery cells provided in the rectenna solar-battery hybrid panels 22 come into an unusable state across the ages, etc., as long as the power generation satellite 19 survives, the artificial satellite 21 can obtain electric power; consequently, the lifetime of the artificial satellite 21 can also be extended.

Next, the function of the hybrid electric-source supplying system for artificial satellites according to Embodiment 2 of the present invention is explained referring to FIG. 6. In FIG. 6, numeral 25 denotes a solar battery cell for receiving the sunlight 18 and generating dc electric power; and numeral 26 denotes a microwave receiving antenna array, for receiving the microwave 20 transmitted from the power generation satellite 19, in which the microwave receiving antenna elements illustrated in FIG. 1-FIG. 4 are arranged in an array. Numeral 27 denotes a rectifying circuit for converting and rectifying into dc electric power the microwave power received by the microwave receiving antenna array 26; and numeral 28 denotes a rechargeable battery in which outputted power from the rectenna solar-battery hybrid panels 22 is charged. In the rectenna solar-battery hybrid panels 22, the solar battery cell 25, the microwave receiving antenna array 26, and the rectifying circuit 27 are configured and functions similarly to those of the examples illustrated in FIG. 1-FIG. 4 explained in Embodiment 1. Here, in FIG. 6, the circuits and the elements in which the same numerals are used as in FIG. 5 represent the same or equivalent ones in FIG. 5.

As illustrated in FIG. 6, the output power from the rectenna solar-battery hybrid panels 22 includes two kinds of dc electric power amounts, one of which is obtained by the solar battery cell 25, and the other is obtained through the microwave 20, having been transmitted from the power generation satellite 19, which is received by the microwave receiving antenna array 26, and converted into dc power by the rectifying circuit 27. The two kinds of the output power each are supplied in parallel into the rechargeable battery 28, which is therefore charged by the two kinds of output power one by one or simultaneously by the two.

Moreover, in the hybrid solar photovoltaic generation system for artificial satellites illustrated in FIG. 5 and FIG. 6 according to Embodiment 2 of the present invention, if the rectenna solar-battery hybrid panels are installed in the power generation satellite 19, and functions for converting into microwave power dc electric power obtained by photovoltaic generation, etc. and for transmitting the microwave power are installed in the artificial satellite 21, a satellite system in which electric power can be complemented each other can be established.

Next, in the hybrid solar photovoltaic generation system for artificial satellites according to Embodiment 2 of the present invention, an electric-power transmitting method in response to orbital positions of the artificial satellite is explained using FIG. 7. FIG. 7 is a view in which an astronomic object such as the earth, and the orbit of an artificial satellite that moves around the astronomic object such as the earth are viewed from the North Pole; here, the artificial satellite 21 in FIG. 7 moves anticlockwise around the astronomic object such as the earth. In FIG. 7, numeral 29 denotes an astronomic object such as the earth; and numeral 30 denotes the revolution orbit of the artificial satellite 21. 1 FIG. 7, the circuits and the elements in which the same numerals are used as in FIG. 5 represent the same or equivalent ones in FIG. 5.

The position of the artificial satellite 21 varies in the order of A, B, C along the revolution orbit 30. Here, from a positional relationship between the sun 17 and the astronomic object 29, the artificial satellite 21 is eclipsed at the position B. At the positions A and C, the artificial satellite 21 receives sunlight from the sun 17; thus, electric power can be generated in itself by the solar battery. However, at the position B, the artificial satellite 21 cannot generate electric power by the photovoltaic generation. Here, in the power generation satellite 19 that lies at a position where the photovoltaic generation is possible, generated electric power is converted into microwave power, and the microwave power is then transmitted towards the artificial satellite 21 from the microwave transmitting antenna provided in the power generation satellite 19. Because the artificial satellite 21 has the rectenna solar-battery hybrid panels, the microwave power transmitted from the power generation satellite 19 is received by the microwave receiving antenna array, and is made to be electric power by converting and rectifying it into dc electric power. Moreover, when the artificial satellite 21 lies not only at the eclipsed position B, but also at the positions A and C where the photovoltaic generation is possible, if a system is configured in such a way that the power generation satellite 19 converts into microwave power electric power obtained by the photovoltaic generation and then transmits it, and at the same time the artificial satellite 21 receives the transmitted microwave power and converts it into dc electric power, the artificial satellite 21 can obtain electric power from both of this transmitted electric power and the electric power generated therein by the photovoltaic generation.

In FIG. 7, the power generation satellite 19 may be placed in a different orbit from or in the same orbit as the artificial satellite 21. In a case in which the power generation satellite 19 and the artificial satellite 21 are placed in different orbits from each other, the power generation satellite 19 can be operated as a power generating station whose mission is to generate dc electric power, convert it into microwave power, and transmit the microwave power to various artificial satellites. In a case in which the power generation satellite 19 and the artificial satellite 21 are placed in the same orbit, the power generation satellite 19 can be generally operated as an exclusive power generation unit during the time period while the artificial satellite 21 is in an eclipse. In such a case, the power generation satellite 19 and the artificial satellite 21 can be considered as a grouped satellite system that performs a united mission based on grouped flight. FIG. 8 is a schematic view explaining, when the artificial satellite and the power generation satellite are placed in the same orbit, the placement of both the satellites in the hybrid solar photovoltaic generation system according to Embodiment 2 of the present invention. Using this figure, the positional relationship is explained when the distance between the artificial satellite 21 and the power generation satellite 19 in the orbit becomes minimum.

In FIG. 8, providing that the position where the artificial satellite 21 is placed in the orbit is M, and the position where the power generation satellite 19 is placed in the orbit is E, the minimum angle of angle MOE in which the artificial satellite 21 and the power generation satellite 19 are not simultaneously eclipsed is given by the following equation:
Angle MOE (the minimum, degree)=2×sin⁻¹(r/R)
where r represents the radius of the astronomic object 29, R represents the distance from the center of the astronomic object 29 to the orbit. Therefore, by placing the artificial satellite 21 and the power generation satellite 19 in the orbit at an angle not narrower than the above angle, when the artificial satellite 21 is not eclipsed, electric power can be obtained by its solar photovoltaic generation, meanwhile when the artificial satellite 21 is eclipsed, electric power can be obtained from the microwave power transmitted from the power generation satellite 19. Here, as long as the power generation satellite 19 is maintained at an angle not narrower than the minimum value of the angle MOE, the power generation satellite 19 may be placed ahead of or behind the artificial satellite 21 in its moving direction in the orbit.
Embodiment 3.

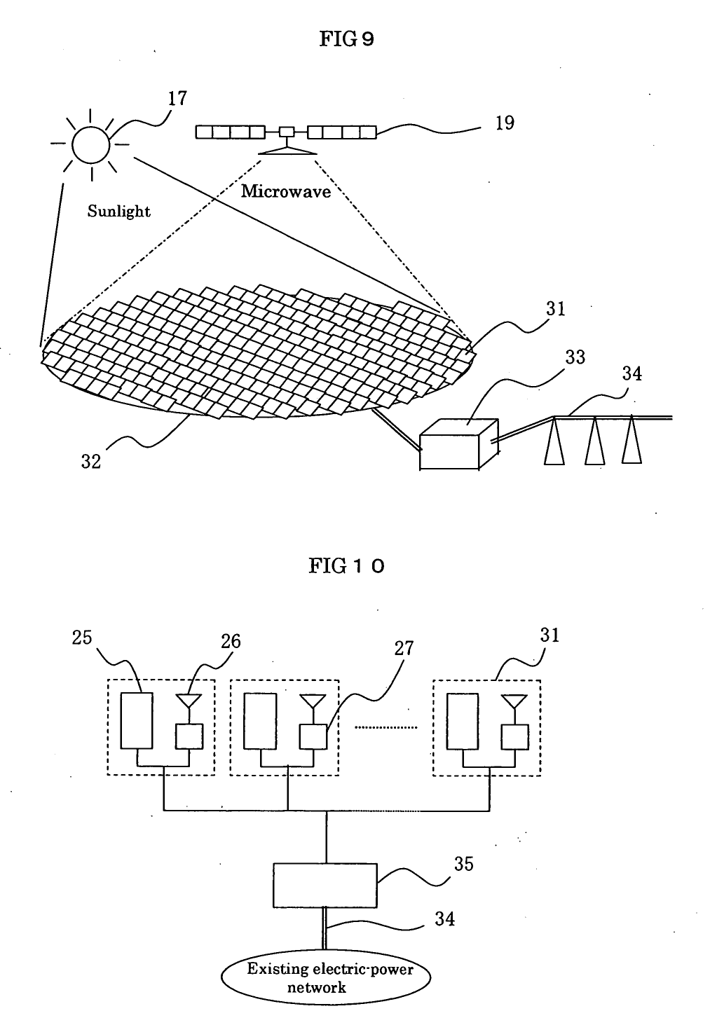

A hybrid solar photovoltaic generation system according to Embodiment 3 of the present invention is explained using FIG. 9 and FIG. 10. FIG. 9 is an outline view illustrating a hybrid solar photovoltaic generation system according to Embodiment 3 of the present invention, and FIG. 10 is a configurational block diagram illustrating the hybrid solar photovoltaic generation system according to Embodiment 3 of the present invention. In FIG. 9, numeral 31 denotes rectenna solar-battery hybrid panels, which are the same as those in FIG. 1-FIG. 4 having been explained in Embodiment 1. Numeral 32 denotes a hybrid panel group in which a plurality of the rectenna solar-battery hybrid panels 31 is arranged. Numeral 33 denotes an electric-powercontrol equipment for controlling the hybrid panel group 32, combining dc electric power outputted from the hybrid panel group 32, and stabilizing the obtained electric power; and numeral 34 denotes transmission lines for supplying to an existing electric power network the electric power combined by and outputted from the electric-powercontrol equipment 33. In the electric-powercontrol equipment 33, its functions may be allocated to each separate unit, such as a controlling unit for controlling the hybrid panel group 32, and an electric-power combining unit for combining and stabilizing the electric power. The hybrid solar photovoltaic generation system according to Embodiment 3 is mainly composed of the hybrid panel group 32, the electric-power-control equipment 33, and the optional transmission lines 34. This hybrid solar photovoltaic generation system may be further composed of a transmitting antenna for transmitting to the power generation satellite 19 a pilot signal. In this case, the power generation satellite 19 receives the pilot signal from a power generation base, and the microwave transmission from the power generation satellite 19 is directed towards the hybrid panel group 32 in such a way that the microwave is transmitted towards the direction from which the pilot signal has been transmitted. In FIG. 9, sunlight from the sun 17 is incident on the hybrid panel group 32; moreover, the power generation satellite 19 in space converts into the microwave power the electric power having been generated thereby, and transmits the microwave power from the microwave transmitting antenna to the hybrid panel group 32. Here, the hybrid solar photovoltaic generation system according to Embodiment 3 may be defined as a configuration excluding the power generation satellite 19, or including the power generation satellite 19.

It is said that in order to obtain a meaningful amount of electric power by the solar photovoltaic generation an extensive area is needed. For example, a needed area is estimated to be 9000 m² for constructing a solar-battery panel that has an electric-power generation capacity of 300 kW; moreover, even if the panel occupies such an extensive area, theoretically, the solar photovoltaic generation can be performed only in the daytime when sunlight is incident. Moreover, when it is cloudy, because its generation efficiency decreases, despite the extensive occupied area, it is difficult to obtain a stable amount of electric power. However, although in the electric power base to which the hybrid solar photovoltaic generation system according to Embodiment 3 of the present invention is applied, an area needed for constructing a receiving antenna that receives the microwave power transmitted from the power generation satellite, etc. is estimated to be approximately several kilometers in diameter, and its needed area is therefore more extensive than that for the solar photovoltaic generation according to Embodiment 3 of the present invention, because electric power can be not only obtained by the solar photovoltaic generation but also stably obtained from the transmitted microwave power, combining these can secure a stable amount of generated power.

Next, a configurational block of an electric power base according to Embodiment 3 of the present invention is explained referring to FIG. 10. In FIG. 10, numeral 35 denotes an electric-power combining unit for combining dc electric power outputted from the plurality of rectenna solar-battery hybrid panels 31 and stabilizing the combined electric power. The rectenna solar-battery hybrid panels 31 are the same as those in the examples illustrated in FIG. 1-FIG. 4 that have explained in Embodiment 1, and, similarly to those in the examples, include the solar batteries 25, the microwave receiving antenna arrays 26, and rectifying circuits 27. Here, the microwave receiving antenna array 26 is configured by arranging the microwave receiving antenna elements in an array.

In a plurality of the solar battery cells 25 arranged on each of the rectenna solar-battery hybrid panels 31, dc electric power is obtained from incident sunlight by the photovoltaic conversion. Moreover, dc electric power is obtained from the microwave power that has been transmitted from the power generation satellite 19, etc., received by the microwave receiving antenna arrays 26, and then converted into dc electric power by being rectified. The dc electric power obtained by the plurality of rectenna solarbattery hybrid panels 31 is combined together in the electric-power combining unit 35, and stabilized; then, the power is supplied to an existing electric power network through the transmission lines 34. Here, the electric-power combining unit 35 may have a built-in rechargeable battery for stabilizing the output dc electric power.

With the configuration described above, although the conventional solar photovoltaic generation systems can obtain electric power only during the daytime in the fine or cloudy weather in which sunlight is incident, in the hybrid solar photovoltaic generation system according to Embodiment 3 of the present invention, electric power can be obtained by the microwave power transmitted from the power generation satellite, etc. even for a period, such as at night and in the cloudy daytime, during which sunlight is not incident; therefore, a stable power generation system as an electric power source can be constructed.

Embodiment 4.

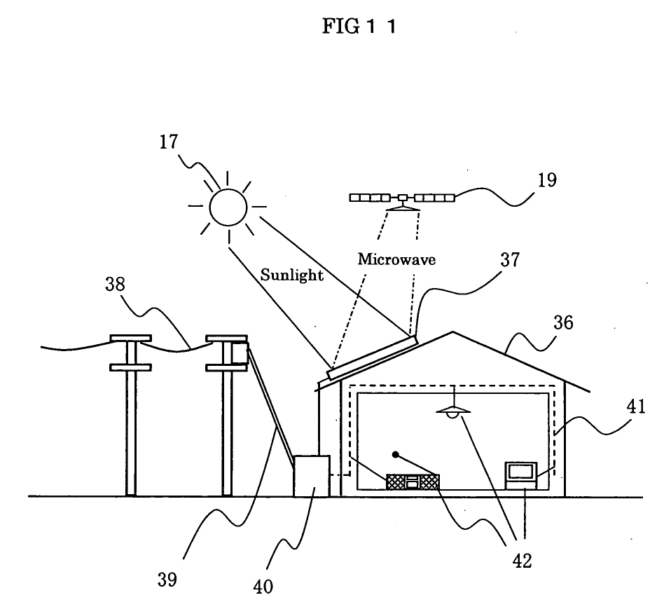

A hybrid solar photovoltaic generation system, for buildings such as a house, according to Embodiment 4 of the present invention is explained referring to FIG. 11. In FIG .II, numeral 36 denotes a building such as a house; and numeral 37 denotes a rectenna solar-battery hybrid panel fixed to the building 36. The rectenna solar-battery hybrid panel 37 has a similar configuration to those in examples illustrated in Fig.-FIG. 4 having been explained in Embodiment 1. Numeral 38 denotes an existing electric power network for supplying electric power to a house, etc. through the transmission lines; and numeral 39 denotes an electric power cable for bilaterally supplying electric power between the sides of the building 36 and the existing electric power network 38. Numeral 40 denotes an electric power controller for supplying to the building 36 the electric power obtained both by the rectenna solar battery hybrid panel 37 and through the existing electric power network 38, and for supplying to the existing electric power network 38 the electric power obtained by the rectenna solar-battery hybrid panel 37. Numeral 41 denotes an in-building electric-power network wired inside the building 36; and numeral 42 denotes electrical appliances used inside the building 36.

The rectenna solar-battery hybrid panel 37 obtains dc electric power through photovoltaic conversion of sunlight, and also obtains dc electric power by receiving the microwave power transmitted from the power generation satellite, etc. Each of the dc electric power obtained by the rectenna solar-battery hybrid panel 37 is combined together, stabilized by the electric power controller 30, and then supplied to the in-building electric-power network 41. The electrical appliances are connected to the in-building electric-power network 41, and obtain its driving power from the in-building electric-power network 41. For example, due to a plurality of the electrical appliances 42, and the electrical appliances that need relatively large electric power being connected to the in-building electric-power network 41, when electric-power is demanded to exceed the amount that is obtainable by the rectenna solar-battery hybrid panel 37, that is, when the amount of the electric power obtained by the rectenna solar-battery hybrid panel 37 is less than the electric-power demanded through the in-building electric-power network 41, the electric power controller 40 supplies power to the in-building electric-power network 41 to fill the shortage, through the electric power cable 39 from the existing electric power network 38. On the contrary, when electric power through the in-building electric-power network 41 is less than that obtained and supplied from the rectenna solar-battery hybrid panel 37, that is, when the amount of the electric power obtained from the rectenna solar-battery hybrid panel 37 exceeds the electric-power demand through the in-building electric-power network 41, the electric power controller 40 supplies through the electric power cable 39 remaining electric power to the existing electric power network 38. Here, by additionally providing the electric power controller 40 with a function for communicating to electric-power supply organizations such as an electric power company the amount of the electric power having been supplied to the existing electric power network 38, the remaining electric power generated by the hybrid solar photovoltaic generation system for buildings can be sold. Moreover, in the hybrid solar photovoltaic generation system for buildings according to Embodiment 4 of the present invention, differing from conventional solar photovoltaic generation systems for buildings such as a house, stable electric power can always be obtained regardless of in the daytime or at night. Furthermore, because the hybrid solar photovoltaic generation system for buildings according to Embodiment 4 of the present invention supplies to the existing electric power network the remaining electric power, the load on a power generating station supplying electric power to enisting electric power networks can be reduced.

What is claimed is:

1. A rectenna solar-battery hybrid panel comprising:
a plurality of solar battery cells for receiving sunlight and converting the sunlight into electricity;
a plurality of microwave receiving antenna elements for receiving microwaves transmitted through space; and
a rectifying circuit for rectifying the microwaves received by the microwave receiving antenna elements; whereby
electric power is obtained from output of the solar battery cells and the rectifying circuit.

2. A rectenna solar-battery hybrid panel as recited in claim 1, further comprising a transparent base, wherein
the plurality of solar battery cells is provided inside the base, the plurality of microwave receiving antenna elements is provided on the front side of the base, and the rectifying circuit is provided on the back side of the base.

3. A rectenna solar-battery hybrid panel as recited in claim 1, further comprising a transparent base, wherein
the plurality of solar battery cells and the plurality of microwave receiving antenna elements are provided inside the base, and the rectifying circuit is provided on the back side of the base.

4. A rectenna solar-battery hybrid panel as recited in claim 1, further comprising:
a transparent base; and
a substrate provided on one of the faces of the base; wherein
the plurality of solar battery cells is provided inside the base, and the plurality of microwave receiving antenna elements and the rectifying circuit are provided on either the front or back side of the substrate.

5. A rectenna solar-battery hybrid panel as recited in claim 1, further comprising:
a transparent base provided with the plurality of solar battery cells; and
a substrate in film form, provided on one of the sides of the base, and provided with the plurality of microwave receiving antenna elements and the rectifying circuit.

6. A hybrid solar photovoltaic generation system comprising:
a bus for controlling an artificial satellite;
a mission module for performing observation as well as communication using the artificial satellite; and
a rectenna solar-battery hybrid panel including a plurality of solar battery cells for receiving sunlight and converting the sunlight into electricity, a plurality of microwave receiving antenna elements for receiving microwaves transmitted through space, and a rectifying circuit for rectifying the microwaves received by the microwave receiving antenna elements, so as to supply to the bus and the mission module electric power generated by the rectenna solar-battery hybrid panel.

7. A hybrid solar photovoltaic generation system comprising:
a set of hybrid panels configured by arranging a plurality of rectenna solar-battery hybrid panels that each includes a plurality of solar battery cells for receiving sunlight and converting the sunlight into electricity, a plurality of microwave receiving antenna elements for receiving microwaves transmitted through space, and a rectifying circuit for rectifying the microwaves received by the microwave receiving antenna elements;
electric-power-control equipment for combining electric power outputted from the set of hybrid panels; and
a transmission line for supplying to an electric-power network electric power combined by and outputted from the electric-power-control equipment.

8. A hybrid solar photovoltaic generation system comprising:
a rectenna solar-battery hybrid panel, installed in a building, including a plurality of solar battery cells for receiving sunlight and converting the sunlight into electricity, a plurality of microwave receiving antenna elements for receiving microwaves transmitted through space, and a rectifying circuit for rectifying the microwaves received by the microwave receiving antenna elements; and
electric-power-control equipment for, when the electric-power supply from the rectenna solar-battery hybrid panel does not meet the electric-power demand inside the building, supplying to the building from an existing electric-power network the electric-power shortfall and for, when electric-power supply from the rectenna solar-battery hybrid panel exceeds the electric-power demand inside the building, supplying to the existing electric-power network the surplus electric power from the rectenna solar-battery hybrid panel.
